(19) United States
(12) Patent Application Publication
(10) Pub. No.: US 2010/0198844 A1
(43) Pub. Date: Aug. 5, 2010

(54) Automatic Code Generation

(75) Inventors: James A. Ribbe, Brea, CA (US); Alex E. Joseph, Fullerton, CA (US); Richard F. Yee, El Segundo, CA (US); Christopher J. Thompson, Fairfax, VA (US); Nasrin Azordegan, Yorba Linda, CA (US)

Correspondence Address: BAKER BOTTS LLP, 2001 ROSS AVENUE, 6TH FLOOR, DALLAS, TX, 75201-2980, US

(73) Assignee: Thales-Raytheon Systems Company, LLC, Fullerton, CA (US)

(21) Appl. No.: 12/362,535

(22) Filed: Jan. 30, 2009

(51) Int. Cl. G06F 17/30

(52) U.S. Cl. 707/755; 707/E17.045; 707/E17.055

(57) ABSTRACT

According to one embodiment, a method for generating code includes receiving a database file describing a database and a database schema. The database includes a plurality of database records. A metadata tag is received, the metadata tag describing a business relationship between two or more database records. The database file and the metadata tag are integrated to form a merged file. Using a computer system, the merged file is converted into code.

### TECHNICAL FIELD

This invention relates generally to the field of computer programming and more specifically to automatic code generation.

### BACKGROUND

In computer science, code is any collection of statements or declarations written in a computer-executable language. Code allows a programmer to communicate with the computer using a reserved number of instructions.

### SUMMARY OF THE DISCLOSURE

In accordance with the present invention, disadvantages and problems associated with previous techniques for code generation may be reduced or eliminated.

According to one embodiment, a method for generating code includes receiving a database file describing a database and a database schema. The database includes a plurality of database records. A metadata tag is received, the metadata tag describing a business relationship between two or more database records. The database file and the metadata tag are integrated to form a merged file. Using a computer system, the merged file is converted into code.

Certain embodiments of the invention may provide one or more technical advantages. A technical advantage of one embodiment may be the capability to provide a single tool for code and document generation. A technical advantage of one embodiment may also include the capability to generate code from a single metadata source. Additionally, a technical advantage of one embodiment may include the capability to generate code in a layered architecture. Additionally, a technical advantage of one embodiment may include the capability to incorporate an active code-generation cycle into the software development process by updating a metadata source and regenerating new code.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a code generation system;

FIG. 2 illustrates one embodiment of a method for generating code;

FIGS. 3A through 3Q illustrate various relationship patterns according to multiple embodiments;

FIG. 4 presents an example composite attribute cache configuration featuring two related tables; and

FIG. 5 presents an example of a multilingual object-relational mapping.

### DETAILED DESCRIPTION OF THE DRAWINGS

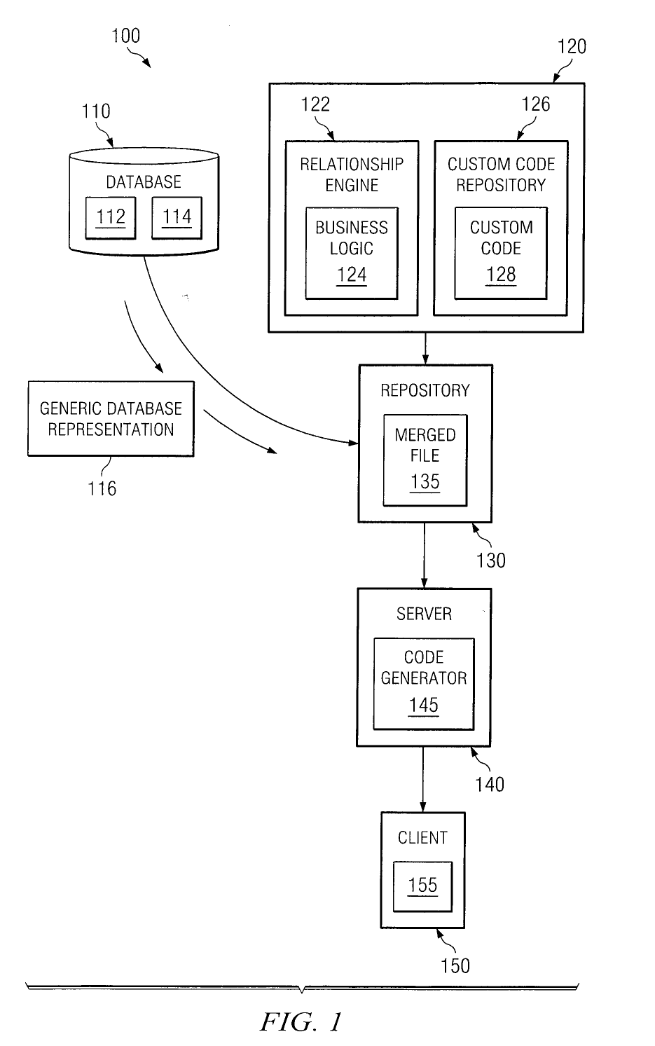

Embodiments of the present invention and its advantages are best understood by referring to FIGS. 1 through 5 of the drawings, like numerals being used for like and corresponding parts of the various drawings.

FIG. 1 illustrates one embodiment of a code generation system 100. The code generation system 100 features components such as a database 110, an engine 120, a repository 130, a server 140, and a client 150, coupled as shown in FIG. 1. In the illustrated embodiment, the database 110 provides generic database data 116, and the engine 120 provides business logic 124 and custom code 128. The repository 130 and the server 140 receive the generic database data 116, the business logic 124, and the custom code 128; convert the data and instructions into code 155; and forward the code 155 to the client 150.

The code generation system 100 represents a communication network that allows a plurality of components to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

The database 110 may include any structured collection of data records 112. A database schema 114 may define the structure and format of the database 110, as well as a set of operations that can be performed on the data records 112.

One example of a database schema 114 is a relational model. The relational model provides a declarative method for specifying data and queries. The relational model defines the location of a data record 112 in terms of relations, attributes, and tuples. A relation may represent a table with columns and rows, the attributes may represent the named columns of the table, and the tuples may represent the rows of the table.

The data records 112 stored in a relational model database may be accessed by executing a query using a query language. A query language is a database computer language designed for the retrieval and management of data records in a relational database. A query language can retrieve the data records according to a key, which can identify each tuple in the relation. A key may be designated by a single attribute or a set of attributes. Keys may be used to join or combine data from two or more relations.

In an object-relational model, a relational database model supports object-oriented programming concepts in the query language. Examples of object-oriented programming concepts include classes, objects, and inheritance. An object is an instance of a class. In turn, a class defines the abstract features of the object, including the object's characteristics (which may correspond to attributes) and the object's behaviors, or “methods.” A method is a subroutine that is exclusively associated with a class or an object. A method may include a sequence of statements to perform an action, a set of input parameters to customize the action, and possibly an output value. Methods provide a mechanism for accessing the data stored in an object or class. Inheritance is the ability of a subclass to inherit attributes and methods from a parent class.

In some embodiments, the database 110 may be structured in a unique vender format. Accordingly, in certain embodiments, the database records 112 and the database schema 114 may be converted into a generic format, illustrated in FIG. 1 as a generic database representation 116. One example of a generic database representation 116 is an object representation, in which one object maps to one database record 112. In some embodiments, the object may be represented by an Enterprise JavaBean, such as an entity bean or a Java Persistence API.

According to the illustrated embodiment, the engine 120 includes a relationship engine 122. The relationship engine 122 may identify relationships among database records. For example, a relationship between two records may be based on business logic 124. The business logic 124 describes the functional processes that handle information exchange between a database and a user interface or an application. The business logic 124 may model real-life business objects, such as an account, a loan, an itinerary, or an inventory. The business logic 124 may include business rules that express business policy, such as policies describing channels, locations, logistics, prices, or products. The business logic 124 may also include workflows that order tasks to be performed, such as passing data from one participant to another. A workflow is a virtual representation of real work, such as a sequence of operations performed in furtherance of a business purpose. The business logic 124 may also prescribe how business objects interact with each other and enforce the routes and the methods by which business objects are accessed and updated.

The engine 120 may also be operable to store or generate additional code. According to the illustrated embodiment, the engine 120 includes a custom code repository 126. The custom code repository may store custom code 128. The custom code 128 may define additional operations to be performed by an application. For example, the custom code 128 may define additional operations to be performed using the data records 112 acquired by executing a query.

The business logic 124 and the custom code 128 may be represented by any type of data file. In some embodiments, the business logic 124 and the custom code 128 may be represented by metadata tags. Metadata is data about data, and may provide information about or documentation of other data managed within an application or environment.

The repository 130 may receive, store, or process the business logic 124 and the custom code 128. The business logic 124 and the custom code 128 may be incorporated with the generic database representation 116 to form a merged file 135. For example, the merged file 135 may incorporate the relationships defined by the business logic 124 into a data model of the database 110. In this example, the merged file 135 defines relationships or provides instructions based on the generic database representation 116 rather than referencing the database 110 directly.

The merged file 135 may include one or more design patterns. A design pattern is a general reusable solution to a commonly occurring problem. A design pattern provides a template for how to solve a problem that can be used in many different situations. For example, object-oriented design patterns may show relationships between classes and objects without specifying the final application classes and objects involved by representing the relationships in a generic template.

Examples of an object-oriented design pattern include a datatype and a data transfer object (DTO). A datatype describes constraints on a data object. A DTO is an object that provides an abstract interface to a database or persistence mechanism, providing some specific operations without exposing details of the database. A DTO may facilitate transfers of data between software application subsystems.

The server 140 may receive the merged file 135 from the repository 130. According to the illustrated embodiment, the server 140 features a code generator 145. The code generator 145 may generate code 155 from the merged file 135 received from the repository 130.

For example, the merged file 135 may include metadata tags originating from the business logic 124. The code generator 145 may convert the merged file 135 into code 155 by replacing the metadata tags with corresponding code. Also, if the business logic 124 includes a workflow that orders tasks to be performed, each step of the workflow would be replaced with a section of code operable to perform that step of the workflow. In addition, if the merged file includes custom code 128, the code 155 generated by code generator 145 may incorporate the custom code 128 as appropriate.

Embodiments of the code generator 145 may include a parser function such as XDoclet. XDoclet is a code-generation library that enables attribute-oriented programming for Java via insertion of metadata tags. XDoclet may identify design patterns in the merged file 135 and alert the code generator 145. The code generator 145 may then execute a script that inserts code corresponding to the design pattern into the merged file 135.

The code generated by code generator 145 may include any type of code executable by a component, such as the client 150. For example, the code 155 may be in the form of a Java programming language. Java embodiments of the code 155 may include one or more java interfaces. Examples of the java interfaces that may be incorporated into the code 155 include the DTO, a factory session bean interface, a deployment descriptor. A factory session bean interface may provide a mechanism allowing an application to perform the four basic functions of persistent storage: Create, Read, Update, and Delete (CRUD). A deployment descriptor may instruct an external application on how to deploy the code 155. Additional embodiments of code 155 may include any computer-readable artificial language designed to express computations that can be performed by a computer.

Some embodiments of the code 155 may be expressed in a multi-layer architecture. A multi-layer architecture is a logical structuring mechanism for elements in a software solution. For example, a software solution may include four architectural layers: data-mapping, data-access, business service, and adapter.

Components of the code generation system 100 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

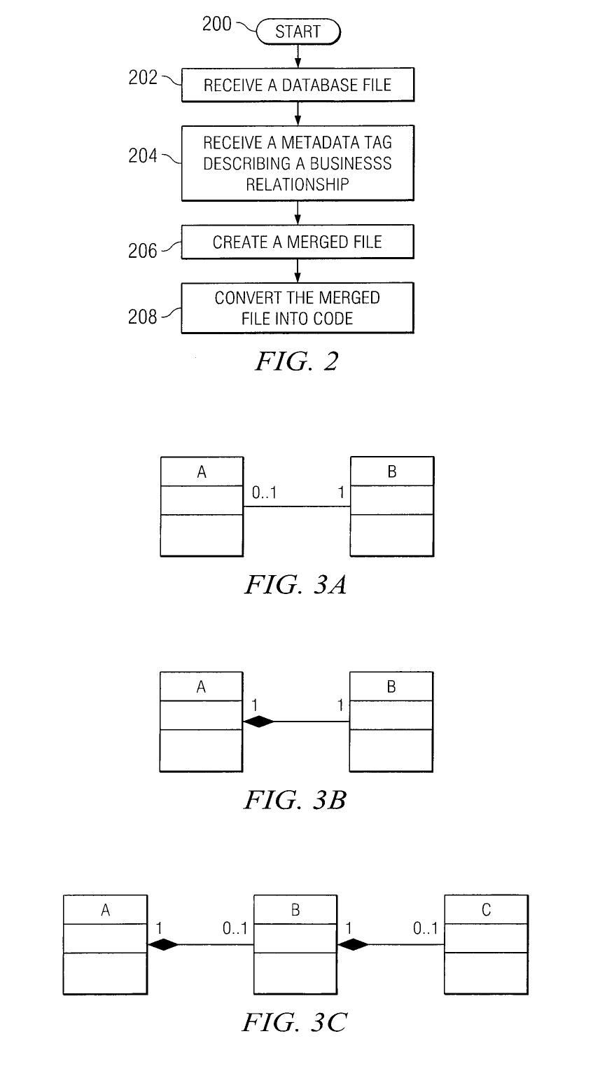

FIG. 2 illustrates one embodiment of a method for generating code. The method of FIG. 2 may incorporate one or more components of the code generation system of FIG. 1.

The method of FIG. 2 starts at step 200. At step 202, a database file is received. The database file describes a database and a database schema. The database and the database schema may correspond to the database 110, the database records 112, and the database schema 114 of FIG. 1.

At step 204, a metadata tag is received describing a business relationship. The business relationship may define a relationship between two records and describe the functional processes that handle information exchange between a database and a user interface or an application. The business relationship may be established by the business logic 124 of FIG. 1.

At step 206, the database file and the metadata tag are incorporated into a merged file. An example of the merged file of step 206 is the merged file 135 of FIG. 1. The merged file 135 may incorporate the relationships received at step 204 into a data model of the database 110.

At step 208, the merged file of step 206 is converted into code. In one embodiment, the merged file is converted into code by parsing the structure of the merged file, identifying design patterns in the merged file, and inserting code into the merged file according to the design patterns. One example of the code created at step 208 may be the code 155 of FIG. 1.

The steps illustrated in FIG. 2 may be repeated during an iterative software-development process. For example, after one iteration during the software-development process, the code 155 may need modification. Rather than modify the code 155 directly, the business logic 124 or the custom code 128 may be modified. The code 155 may then be regenerated according to the steps illustrated in FIG. 2, incorporating the changes to the business logic 124 and the custom code 128 into the code 155.

In an example embodiment, at step 202, a database file may include database records 112 that define a set of account information, such as customer names, contact information, and account balances. The database schema 114 may define the basic structure and functions of the database 110, such as how to delete one or more data records 112. At step 204, the business logic 124 may define additional business relationships. For example, a business relationship defined in the business logic 124 may prohibit a customer from borrowing on an account if the customer has a negative account balance. At step 206, the database file and the business logic 124 may be incorporated into a merged file 135. This merged file 135 may include both the database schema 114 relationships and the business logic 124 relationships. At step 208, the merged file 135 may be converted into code 155 by incorporating both the database schema 114 relationships and the business logic 124 relationships. For example, the code 155 may ensure that access and modification of the database 110 complies with any business rules and relationships defined in the business logic 124.

### EXAMPLES

The following section provides example techniques and code for executing the steps illustrated in FIG. 2. The following examples describe an “Autogen” system operable to perform one or more of the steps illustrated in FIG. 2.

### Metadata Tags

Class-Level Tag Example:

/**
* @ejb.bean
* name=“AcmFactory”
*/
abstract public class AcmFactoryBean extends FactoryObjectBean
implements SessionBean {
:
}

Method-Level Tag Example:

```
abstract public class AcmBean implements EntityBean {
  /**
  * @ejb.persistence
  * column-name=“ACM_DESIGNATOR”
  */
  abstract public String getAcmDesignatorCMF( ) throws EJBException;
}
```

Field-Level Tag Example:

```
/**
* @autogen.factory-hydration
*  name=“acoGraph1”
*/
public static final RelationshipSpecifierWFE[ ] acoGraph1 = {
    AcoWFE.ACM,
    :
};
```

Standard Class-Level Tags Example:

```
@ejb.bean
    name=<ejb name (sans “bean” suffix)>
@autogen.bean
    beantype=“entity” | “session“ | “mdb”
    pattern=“fdas” | “legacy”
    generate=“true” | “false”
    objecttype=“domainobject” | “factory” | “composite” |
“businessservice” | “adapter”
```

Standard Entity-Specific Class-Level Tags Example:

```
@autogen.bean
    // optional: default is <table name>_PID
    pk-column-name=<name of table pk column>
@ejb.finder
    signature=“java.util.Collection findAll( )”
    query=“Select Object(e) From AcmBean as e“
// required only if WebLogic QL extensions are needed for finder queries
@weblogic.finder
    signature=“java.util.Collection findAll( )”
    query=“Select Object(e) From AcmBean as e ORDERBY
e.acmSeqNbrCMF ASC“
```

Domain Object Entity Class-Level Tag Example:

```
/**
@ejb.bean
  name=“Acm”
@autogen.bean
  beantype=“entity”
  pattern=“fdas”
  generate=“true”
  objecttype=“domainobject”
@ejb.finder
  signature=“java.util.Collection findAllByShape(java.lang.String shape)”
  query=“Select Object(e) From Acm as e Where e.acmShapeCMF = ?1”
*/
abstract public class AcmBean extends DomainObjectBean implements
EntityBean {
        :
}
```

Composite Attribute Entity Class-Level Tag Example:

```
/**
@ejb.bean
    name=“GeoObject”
@autogen.bean
    beantype=“entity”
    pattern=“fdas”
    generate=“true”
    objecttype=“composite”
*/
abstract public class GeoObjectBean extends DomainObjectBean
implements EntityBean {
        :
}
```

Standard Entity Method-Level Tags Example:

@ejb.interface-method
view-type=“local” | “remote” | “both” // default is “remote”

The “@ejb.interface-method” may be used to define custom business methods for entity beans. For FDAS (Framework Database Access Service) entity beans, if the method conforms to the JavaBeans read property naming convention (e.g., “getXyz( )”), AutoGen may add the method (and its corresponding “set” method) to the generated DTO class. For read-only values (e.g., “getxyz( )” returns a derived value), a “get” method may be defined. For read/write values, a “set” method may also be defined. AutoGen may provide “get” and “set methods for DTO classes, even if only a “get” method is specified in the entity bean class.

Standard Entity Persistence Method-Level Tags Example:

@ejb.persistence
column-name=“<db column name>”
@autogen.persistence

| | |
|---|---|
| readonly = “true” \| “false” | // default is “false” |
| multilingual=“true” \| “false” | // default is “false” |

/* Supported for backward compatibility. @autogen.dbms-column-type
should be used */

| | |
|---|---|
| @weblogic.dbms-column-type OracleBlob \| OracleClob | // note: no |

quotations required for value
/* Should be used instead of @weblogic.dbms-column-type. Overrides
weblogic tag if both are defined. */

| | |
|---|---|
| @autogen.dbms-column-type Blob \| Clob | // note: no |
| quotations required for value | |

Standard Entity Relationship Method-Level Tags Example:

```
@ejb.relation
    name=“<name of relation>”
    role-name=“<object role in the relationship>”
    cascade-delete=“true” | “false”
    target-role-name=“<role of object on other side of relationship>”
    target-ejb=“<name of entity bean (i.e. object) on other side of
relationship>”
    target-cascade-delete=“true” | “false”
    target-multiple=“true” | “false”
@autogen.relation  // Overrides @weblogic.relation join-table-name
    type=“association” | “composition”
    expose = “true” | “false”
    join-table-name=“<db link table name>”
@weblogic.relation // Deprecated, although still functional. Use
autogen.relation instead.
    join-table-name=“<db link table name>”
@autogen.column-map
    key-column=“<PK column name>”
    foreign-key-column=“<FK column name>”
    mandatory=“true” | “false”
@autogen.target-column-map
    key-column=“<PK column name>”
    foreign-key-column=“<FK column name>”
    mandatory=“true” | “false”
@autogen.workflow
    readonly=“true” | “false”
```

The “readonly” attribute in “@autogen.workflow” may be used to designate that traversal across the relationship is read-only during a factory “update.” A “readonly” relationship traversal enables establishment of a relationship to the domain object on the other side of the relationship without updating the domain object.

Entity Custom Code Tags Example (Class-Level Tags):

```
@autogen.entity-joinpoint
    begin-ejbCreate=“<insert method call or one or more Java code
statements>”
    end-ejbCreate=“<insert method call or one or more Java code
statements>”
    begin-ejbPostCreate=“<insert method call or one or more Java code
statements>”
    end-ejbPostCreate=“<insert method call or one or more Java code
statements>”
```

Entity Custom Code Tags Example (Method-Level Tags):

```
@autogen.entity-joinpoint
  begin-setter=“<same as class-level joinpoint>”
  end-setter=“<same as class-level joinpoint>”
  begin-getter=“<same as class-level joinpoint>”
  end-getter=“<same as class-level joinpoint>”
  begin-add=“<same as class-level joinpoint>”
  end-add=“<same as class-level joinpoint>”
  begin-remove=“<same as class-level joinpoint>”
  end-remove=“<same as class-level joinpoint>”
  begin-init=“<same as class-level joinpoint>”
  end-init=“<same as class-level joinpoint>”
```

A join point (or “joinpoint”) is a point in the control flow of a program. In aspect-oriented programming, a set of join points may be described as a pointcut. A join point may represent where the main program and the aspect meet. In aspect-oriented programming, an aspect is a part of a program that cross-cuts the program's core concerns.

AutoGen may generate entity bean ejbCreate( ) and ejbPostCreate( ) method implementations with paramenter names that follow a well-defined naming convention. EjbCreate( ) and ejbPostCreate( ) methods may be generated with a parameter list comprised of a DomainObjectDTO object followed by zero or more DomainObjectLocal objects. In this example, the DomainObjectDTO is named “dto.”

There is also an entity bean parameter for each relational foreign key attribute owned by the entity bean implementing the ejbCreate( ) and ejbPostCreate( ) methods. Each entity bean parameter may be named using the Lower CamelCase representation of the relational foreign key column name. CamelCase is the practice of writing compound words or phrases in which the words are joined without spaces and are capitalized within the compounded.

These principles are illustrated by the following example. This example includes a data model with two related tables, labeled as an “ACO Table” and an “ACM Table.” The ACO Table features an ACO_PID(PK) call, and the ACM Tables an ACM_PID(PK) call and at least one ACO_PID(FK) call. In the following example, these tables correspond to the following metadata and generated code. The AcoLocal entity parameter name is derived from the corresponding foreign key column name in the ACM Table, and the parameter names match up in accordance with well-defined naming conventions.

AutoGen Metadata Example:

/** @autogen.bean
* beantype=“entity”
* :
* @autogen.entity-joinpoint
* begin-ejbPostCreate=“doCustom(dto, acoPid);”
*/
abstract public class AcmBean ... { .. }

AutoGen Generated Code Example:

abstract public class AcmBeanCMP ... {
public void ejbPostCreate(DomainObjectDTO, dto, AcoLocal acoPid) {

| | |
|---|---|
| doCustom(dto, acoPid); | // custom code inserted by AutoGen |
| : | // AutoGen generated logic |
| } | |

Other Entity Join Point Parameter Naming Conventions Example:

```
Entity attribute “set<attribute>( )” methods:
  Parameter name = <attributeName>
    example:  public void setName(String name)
Entity “one” relationship “set<relName>( )” method:
  Parameter name = <relName>
    example:  public void setAco(AcoLocal aco)
Entity “many” relationship “add<relName>( )” and
“remove<relName>( )” methods:
  Parameter name = <relname>
    example:  public void addAcm(AcmLocal acm)
      public void removeAcm(AcmLocal acm)
```

Standard Factory-Specific Class-Level Tags Example:

```
@autogen.factory-update
  generate=“true” | “false”
  hydration=“<reference to autogen.hydration field>”
    Note: unspecified hydration reference will default to top-level domain
object hydration only
@autogen.factory-delete
  generate=“true” | “false”
    Note: no hydration reference needed
```

Factory Class-Level Tag Example:

```
/**
@ejb.bean
  name=“AcoFactory”
@autogen.bean
  beantype=“session”
  pattern=“fdas”
  generate=“true”
  objecttype=“factory”
@autogen.factory-update
  generate=“true”
  hydration=“acoGraph1”
@autogen.factory-delete
  generate=“true”
*/
public  class  AcoFactoryBean  extends  FactoryObjectBean
implements SessionBean {
  /**
  * @autogen.factory-hydration
  *  name=“acoGraph1”
  */
  public  static  final RelationshipSpecifierWFE[ ]
acoGraph1  =  { AcoWFE.ACM };
```

Standard Factory-Specific Field-Level Tags Example:

```
@autogen.factory-hydration
  name=“<identifier>”
  strategy=“unordered” | “ordered” | “leveled”
  ordered=“true” | “false”  /* deprecated */
```

For the “@autogen.factory-hydration” tag, the default workflow build strategy is unordered. [[[Mr. Ribbe, can you please provide a brief definition of “hydration”? Thanks.]]] Although the particular order in which Relationship Specified objects are defined in a hydration definition is not important, a use case that requires an unusual DTO graph hydration may require a particular ordering for the Relationship Specifier objects defined in the hydration list.

Factory Field-Level Tag Example:

```
/**
@ejb.bean
  name=“AcoFactory”
@autogen.bean
  beantype=“session”
  pattern=“fdas”
  generate=“true”
  objecttype=“factory”
@autogen.factory-update
  generate=“true”
  hydration=“acoGraph1”
@autogen.factory-delete
  generate=“true”
*/
public class  AcoFactoryBean extends  FactoryObjectBean
implements SessionBean {
  /**
  * @autogen.factory-hydration
  * name=“acoGraph1”
  */
  public  static  final  RelationshipSpecifierWFE[ ]
acoGraph1  =  { AcoWFE.ACM };
}
```

Standard Factory-Specific Method-Level Tags Example:

```
@autogen.factory-finder
  hydration=“<reference to hydration defined in field-level tag>”
  entity-finder-signature=“<entity finder method name>”
  custom-finder-signature=“<name of protected method defined in the
factory bean>”
```

The “custom-finder-signature” attribute supports calls to custom finder methods in the factory. Custom finder methods may be used to support cases where the use of WebLogic's dynamic query interface is required. The “custom-finder-signature” and “entity-finder-signature” attributes may be mutually exclusive. For example, AutoGen may indicate an error if “custom-finder-signature” and “entity-finder-signature” are both defined.

Factory Method-Level Tag Example:

```
/**
  :
  :
*/
public  class  AcoFactoryBean  extends  FactoryObjectBean
implements SessionBean {
  /**
  * @autogen.factory-hydration
  *  name=“acoGraph1”
  */
  public static final RelationshipSpecifierWFE[ ] acoGraph1 = {
    AcoWFE.ACM,
    AcoWFE.ACO_VALIDITY_PERIOD
  };
  /**
  * @autogen.factory-finder
  *  hydration=“acoGraph1”
  *  entity-finder-signature=“findAllByType(type)”
  */
  abstract public IMSFinderResultSet findAllByType(String type) throws
FDASException;
}
```

Factory Custom Code Tags Example (Method-Level Tags):

```
@autogen.factory-joinpoint
  begin-find=“<insert method call or one or more Java statements>”
  end-find=“<insert method call or one or more Java statements>”
```

When invoking methods generated in the auto-generated EJB subclass, the method may be defined as an abstract method in the EJB metadata class. For example:

```
  /** Meta-data definition normally created by Jumpstart tool. Custom
code should not call this method
  *  directly. Instead, the auto-generated wrapper method should be
invoked, as illustrated in this example.
  * @ejb.persistence column-name=“ATTRIBUTE_A”
  */
  abstract public String getAttributeACMF( ) throws EJBException;
  /** method defined to support a join point */
  protected void customMethod(DomainObjectDTO dto) {
    :
    String s = getAttributeA( );  // call to wrapper method auto-
generated by AutoGen
    :
  }
  abstract public String getAttributeA( ) throws EJBException;  //
definition required for compilation
```

The FDAS framework supports a validation hook for each Domain Object Entity. The validate( ) method may be defined in the entity metadata class to support developer-defined validation of the entity's attributes and relationships. The concept of referencing auto-generated methods may be the same as for custom code.

For Example:

```
  /** Validate method defined in Entity meta-data class. Relationship
is defined as 1 □ 1..*, so this
  * method checks to make sure that the “many” relationship is not
less than one (i.e. empty)
  */
  protected void dobValidate( ) throws BusinessRuleException {
    Collection s = getAs( );  // call to relationship wrapper method
auto-generated by AutoGen
    if ( s.isEmpty( ) ) { throw new BusinessRuleException(....); }
  }
  abstract public Collection getAs( ) throws EJBException;  // definition
required for compilation
```

Custom entity business methods may be useful for providing a calculated result for internal service components that access entity beans directly. Custom entity business methods may be useful for exposing a calculated read-only result to external clients. Clients do not necessarily need to know that the attribute is non-persistent.

Custom Entity Business Method Entity Class Example:

/** @ejb.interface-method view-type=“local” */
public Long calculateRate( ) throws javax.ejb.EJBException { .. }
/** @ejb.interface-method view-type=“local” */
public Long getTotal( ) throws javax.ejb.EJBException { .. }

Custom Entity Business Method Entity Local Interface Example:

public Long calculateRate( ) throws javax.ejb.EJBException;
public Long getTotal( ) throws javax.ejb.EJBException;

Custom Entity Business Method DTO Class Example:

public Long getTotal( ) { .. } // added due to JavaBean naming
convention
public void setTotal(Long) { .. } // required in order to set value in
DTO

### Patterns

In a data model, data entries may be characterized by state, and relationships may be characterized by cardinality and roles. In an object model, objects may be characterized by interface, state, and/or behavior; relationships may be characterized by cardinality, directionality, and/or roles.

In the object model, objects may exhibit several basic characteristics, such as encapsulation, inheritance, and/or polymorphism. Encapsulation refers to a state behind a well-defined interface. The state is only accessible from the well-defined interface, and the interface provides services that operate on the state. Inheritance refers to an object's ability to inherit state and behavior from an ancestor object. Polymorphism refers to objects with the same interface that can exhibit different behavior depending on the actual implementation behind the interface.

When two objects share a relationship, each object plays a particular role in that relationship. There are two fundamental types of roles in a relationship: independent and dependent. An object playing an independent role exists independently of the object on the other side of the relationship. The object controls its own lifecycle with regard to the role it plays in the relationship. An object playing a dependent role does not exist independently of the object on the other side of the relationship. Instead, its lifecycle is managed completely by the object on the other side of the relationship. An object plays a particular role for each relationship that it has to another object; for example, an object with five relationships will play five different roles.

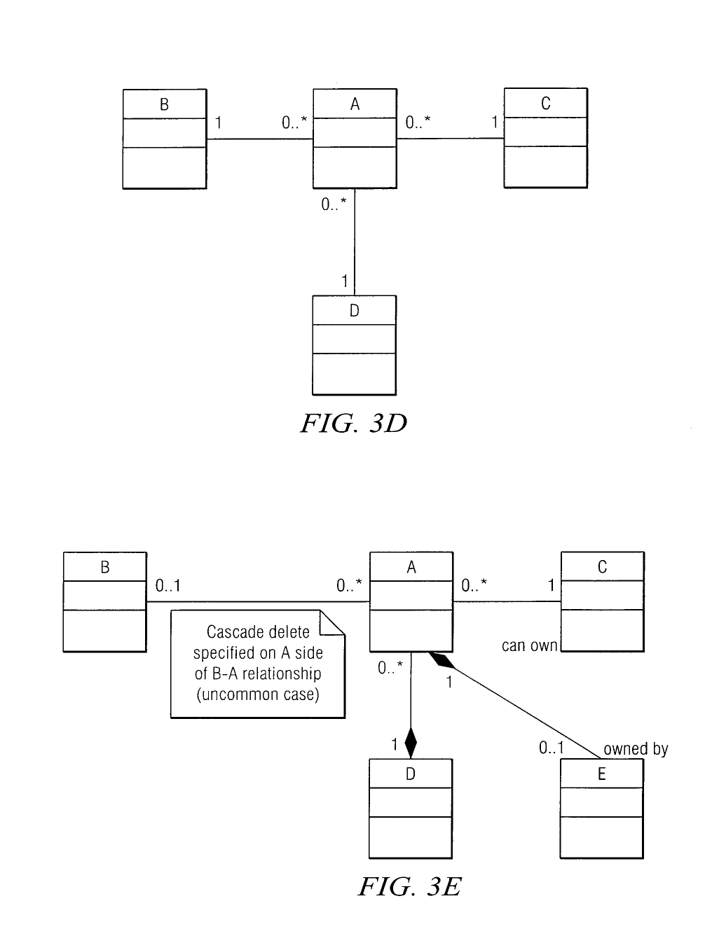

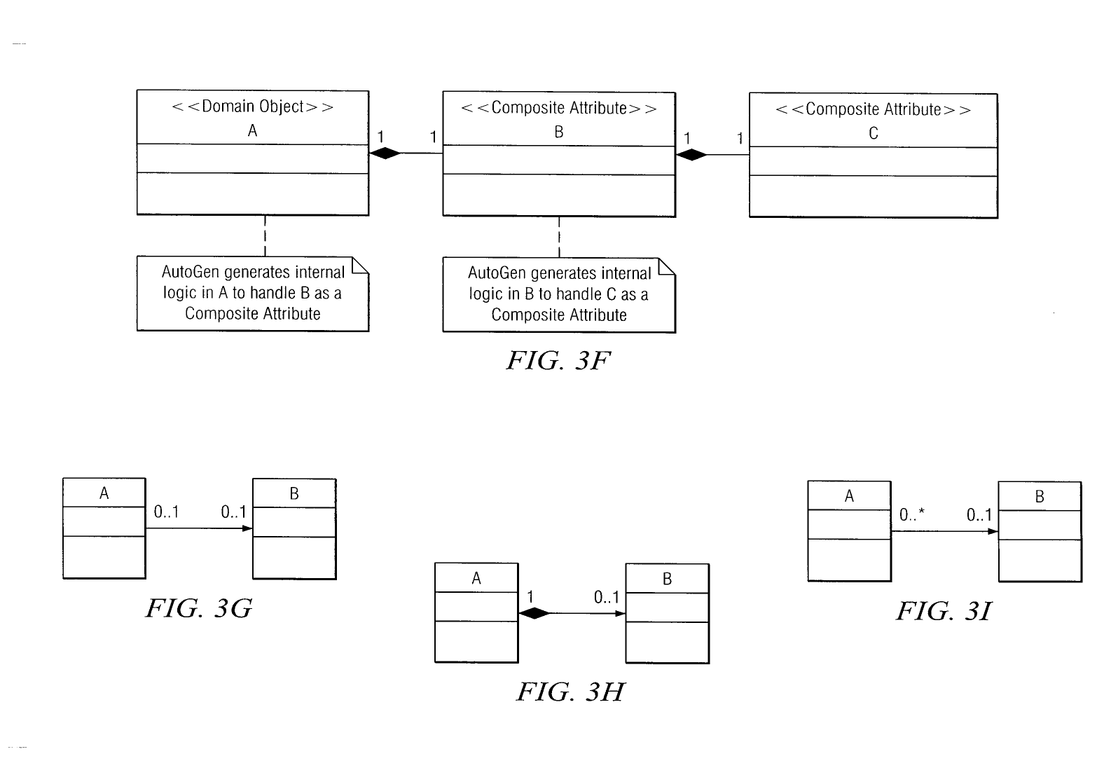

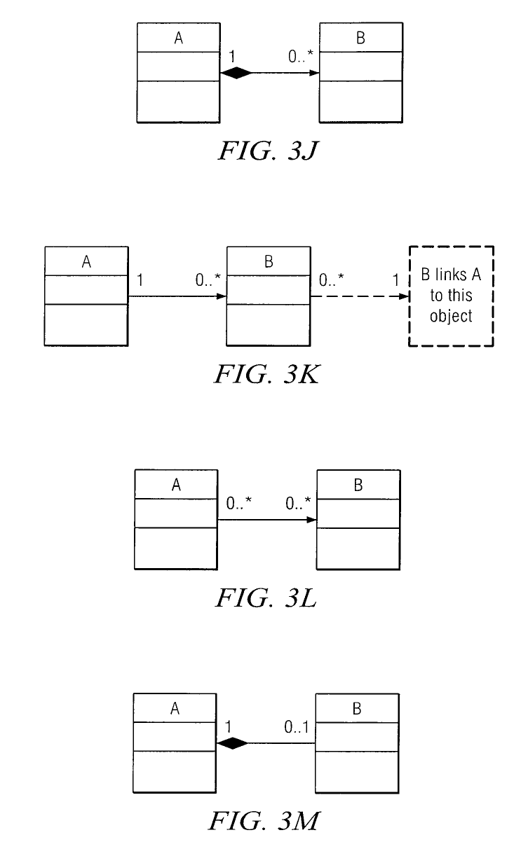

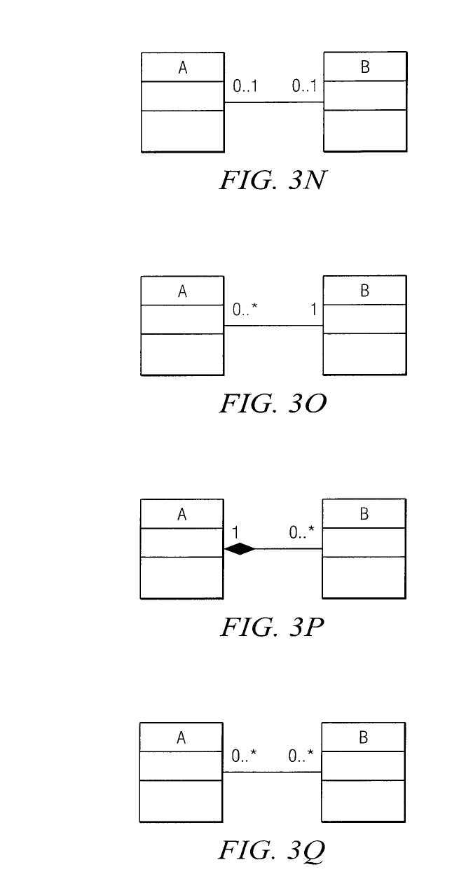

FIGS. 3A through 3Q illustrate various relationship patterns according to multiple embodiments. FIG. 3A illustrates an association relationship. In an association relationship, both objects A and B play independent roles. Thus, deletion of one object does not result in the deletion of the other object. Deletion of the relationship does not result in automatic deletion of either object. One variant is a cascade delete specified for one side of a relationship: deletion of the domain object on the “non-cascade delete” side of the relationship results in deletion of the other domain object, but deletion of the relationship does not result in automatic deletion of either domain object. Cascade Deletes are usually used to implement an application-level business rule.

FIG. 3B illustrates a composition relationship. In a composition relationship, one object (A) plays an independent role, and the other object (B) plays a dependent role. Thus, deletion of the independent parent object results in automatic deletion of the dependent object, and deletion of the relationship results in automatic deletion of the dependent object. The Cascade Delete may be specified on one side of the relationship in order to identify to AutoGen the domain object playing the dependent role.

FIG. 3C illustrates multiple roles for a domain object. Object B plays multiple roles, one per relationship. Objects A and B have a one-to-one composition relationship, and objects B and C have a one-to-one composition relationship. In relationship A-B, A plays the independent parent role, and B plays the dependent role. In relationship B-C, B plays the independent role, and C plays the dependent role. Deletion of A results in automatic deletion of B, which in turn causes deletion of C. Deletion of the A-B relationship results in automatic deletion of B, which causes deletion of C. Deletion of B results in automatic deletion of C. Deletion of the B-C relationship results in automatic deletion of C.

FIG. 3D illustrates standard association object relationships. An association object can form a relationship between two, three, or more objects. An association object often represents a configuration, or some movement or interval in time (e.g., a sales transaction, or an EmconStateTime activation). In this example, A is an association object that forms a ternary relationship between objects B, C, and D. Since all of A's relationships are mandatory, B, C, and D, cannot be deleted.

FIG. 3E illustrates association object relationship variants. A is an association object forming a ternary relationship between B, C, and D. Deletion of B causes cascade deletion of A (such as per an application business rule). Removal of the B-A association does not result in the deletion of A. Deletion of C or removal of the C-A association relationship, however, is not allowed. Deletion of D causes dissolution of the ternary relationship via cascade deletion of A. Removal of the D-A composition relationship dissolves the ternary relationship via cascade deletion of A. E plays the role of the dependent object in its composition relationship to A.

FIG. 3F illustrates composite attribute entity relationships. A one-to-one composition relationship exists between domain object entity A and composite attribute entity B and between composite attribute entity B and composite attribute entity C. In a composition relationship, AutoGen may automatically detect and generate composition attribute handling logic in the entity bean playing the parent role if AutoGen detects that the entity bean playing the dependent role is a composite attribute entity.

FIG. 3G illustrates a uni-directional one-to-one association model. A and B play independent roles, and A has an optional relationship to B. The ABean may have a “BPID” non-mandatory foreign key column, as represented in the following tag:

```
/**
  * @autogen.relation
  *  type=“association”
  *
  * @ejb.relation
  *  name=“A-B-BPID”
  *  role-name=“A-can-reference-B“
  *  target-ejb=“B”
  *  target-role-name=“B-can-be-referenced-by-A”
  *
  * @autogen.column-map
  *  foreign-key-column=“BPID”
  *  key-column=“BPID”
  */
public abstract BLocal getBCMR( ) throws EJBException;
```

FIG. 3H illustrates a uni-directional one-to-one composition model. A plays an independent role, and B plays a dependent role. A may or may not own B. The BBean may have an “APID” foreign key column to correspond to the following ABean tag:

```
/**
  * A one side
  *
  * @autogen.relation
  *  type=“composition”
  *
  * @ejb.relation
  *  name=“A-B-APID”
  *  role-name=“A-has-a-B“
  *  target-ejb=“B”
  *  target-role-name=“B-belongs-to-A”
  *  target-cascade-delete=“yes”
  *
  * @autogen.target-column-map
  *  foreign-key-column=“APID”
  *  key-column=“APID”
  *  mandatory=“true”
  */
public abstract BLocal getBCMR( ) throws EJBException;
```

FIG. 3I illustrates a uni-directional many-to-one association model between objects A and B. A and B play an independent role, and A has an optional relationship to B. The ABean may have a “BPID” non-mandatory foreign key column, as represented in the following tag:

```
/**
  * A many side
  *
  * @autogen.relation
  *  type=“association”
  *
  * @ejb.relation
  *  name=“A-B-BPID”
  *  role-name=“A-may-reference-B“
  *  target-ejb=“B”
  *  target-role-name=“B-may-be-referenced-by-A”
  *  target-multiple=“yes”
  *
  * @autogen.column-map
  *  foreign-key-column=“BPID”
  *  key-column=“BPID”
  */
public abstract BLocal getBCMR( ) throws EJBException;
```

FIG. 3J illustrates a uni-directional one-to-many composition model between objects A and B. A plays an independent role, and B plays a dependent role. A may own zero or more Bs. The BBean may have an “APID” foreign key column to correspond to the following ABean tag:

```
/**
  * One side
  *
  * @autogen.relation
  *  type=“composition”
  *
  * @ejb.relation
  *  name=“A-B-APID”
  *  role-name=“A-contains-Bs“
  *  target-ejb=“B”
  *  target-role-name=“B-belongs-to-A”
  *  target-cascade-delete=“yes”
  *
  * @autogen.target-column-map
  *  foreign-key-column=“APID”
  *  key-column=“APID”
  *  mandatory=“true”
  */
public abstract Collection getBsCMR( ) throws EJBException;
```

FIG. 3K illustrates a uni-directional one-to-many association model between objects A and B. A and B play an independent role. This type of relationship may be used to support a relationship to an association object (e.g., a link table is exposed as a first class domain object entity bean). With this type of relationship, B is most likely an association object. If B is an association object, A cannot be deleted if it has a relationship to B since B will contain a non-null (per this example) foreign key reference to A. The BBean may have an “APID” foreign key column to correspond to the following ABean tag:

```
/**
  * One side
  *
  * @autogen.relation
  *  type=“association”
  *
  * @ejb.relation
  *  name=“A-B-APID”
  *  role-name=“A-references-Bs“
  *  target-ejb=“B”
  *  target-role-name=“B-references-an-A”
  *
  * @autogen.target-column-map
  *  foreign-key-column=“APID”
  *  key-column=“APID”
  *  mandatory=“true”
  */
public abstract Collection getBsCMR( ) throws EJBException;
```

FIG. 3L illustrates a uni-directional many-to-many association model between objects A and B. A and B play an independent role, and the relationships between A and B are optional. The ABean may be represented by the following tag:

```
/**
  * @autogen.relation
  *  type=“association”
  *  join-table-name=“AToBLinkTable”
  *
  * @ejb.relation
  *  name=“A-B-AToBLinkTable-APID-BPID”
  *  role-name=“A-references-Bs“
  *  target-ejb=“B”
  *  target-role-name=“B-referenced-by-As”
  *  target-multiple=“yes”
  *
  * @autogen.column-map
  *  foreign-key-column=“APID”
  *  key-column=“APID”
  *
  * @autogen.target-column-map
  *  foreign-key-column=“BPID”
  *  key-column=“BPID”
  */
public abstract Collection getBsCMR( ) throws EJBException;
```

FIG. 3M illustrates a bi-directional one-to-one composition model between objects A and B. A plays an independent parent role, and B plays a dependent role. A may or may not own B. The ABean may be represented by the following tag:

```
/**
  * @autogen.relation
  *  type=“composition”
  *
  * @ejb.relation
  *  name=“A-B-APID”
  *  role-name=“A-has-a-B“
  */
public abstract BLocal getBCMR( ) throws EJBException;
```

The BBean May be Represented by the Following Tag:

```
/** @autogen.relation
  *  type=“composition”
  *
  * @ejb.relation
  *  name=“A-B-APID”
  *  role-name=“B-belongs-to-A“
  *  cascade-delete=“yes”
  *
  * @autogen.column-map
  *  foreign-key-column=“APID”
  *  key-column=“APID”
  *  mandatory=“true”
  */
public abstract ALocal getACMR( ) throws EJBException;
```

FIG. 3N illustrates a bi-directional one-to-one association model between objects A and B. Objects A and B play an independent role, and A has an optional relationship to B. The ABean may be represented by the following tag:

```
/**
  * @autogen.relation
  *  type=“association”
  *
  * @ejb.relation
  *  name=“A-B-BPID”
  *  role-name=“A-references-a-B“
  *
  * @autogen.column-map
  *  foreign-key-column=“BPID”
  *  key-column=“BPID”
  */
public abstract BLocal getBCMR( ) throws EJBException;
```

The BBean May be Represented by the Following Tag:

```
/**
  * @autogen.relation
  *  type=“association”
  *
  * @ejb.relation
  *  name=“A-B-BPID”
  *  role-name=“B-is-referenced-by-A“
  */
public abstract ALocal getACMR( ) throws EJBException;
```

FIG. 3O illustrates a bi-directional many-to-one association model between objects A and B. Objects A and B play an independent role, and A has a mandatory relationship to B. The ABean may be represented as:

```
/**
  * @autogen.relation
  *  type=“association”
  *
  * @ejb.relation
  *  name=“A-B-BPID”
  *  role-name=“A-must-reference-a-B“
  *
  * @autogen.column-map
  *  foreign-key-column=“BPID”
  *  key-column=“BPID”
  *  mandatory=“true”
  */
public abstract BLocal getBCMR( ) throws EJBException;
```

The BBean May be Represented by the Following Tag:

```
/**
  * @autogen.relation
  *  type=“association”
  *
  * @ejb.relation
  *  name=“A-B-BPID”
  *  role-name=“B-can-reference-As”
  */
public abstract Collection getAsCMR( ) throws EJBException;
```

FIG. 3P illustrates a bi-directional one-to-many composition model between objects A and B. A plays an independent role, and B plays an independent role. A may own zero or more Bs. The ABean may be represented as:

```
/**
  * @autogen.relation
  *  type=“association”
  *
  * @ejb.relation
  *  name=“A-B-BPID”
  *  role-name=“A-must-reference-a-B“
  *
  * @autogen.column-map
  *  foreign-key-column=“BPID”
  *  key-column=“BPID”
  *  mandatory=“true”
  */
public abstract BLocal getBCMR( ) throws EJBException;
```

The BBean May be Represented by the Following Tag:

```
/** @autogen.relation
  *  type=“composition”
  *
  * @ejb.relation
  *  name=“A-B-APID”
  *  role-name=“B-contained-by-A“
  *  cascade-delete=“yes”
  *
  * @autogen.column-map
  *  foreign-key-column=“APID”
  *  key-column=“APID”
  *  mandatory=“true”
  */
public abstract ALocal getACMR( ) throws EJBException;
```

FIG. 3Q illustrates a bi-directional many-to-many association model between objects A and B. Objects A and B play an independent role, and the relationships between A and B are optional. The ABean may be represented by the following tag:

/** @autogen.relation
* type=“association”
* join-table-name=“AAndBLinkTable”
*
* @ejb.relation
* name=″A-B-AAndBLinkTable-APID-BPID″
* role-name=“A-references-Bs“
*
* @autogen.column-map
* foreign-key-column=“APID”
* key-column=“APID”
*/
public abstract Collection getBsCMR( ) throws EJBException;

The BBean May be Represented by the Following Tag:

/** @autogen.relation
* type=“association”
*
* @ejb.relation
* name=“A-B-AAndBLinkTable-APID-BPID”
* role-name=“B-references-As”
*
* @autogen.column-map
* foreign-key-column=“BPID”
* key-column=“BPID”
*/
public abstract Collection getAsCMR( ) throws EJBException;

### Tools

Embodiments of the AutoGen system may include an Entity JumpStart and a Factory JumpStart. These two tools provide a command-line “wizard” for generating initial FDAS entity bean and factory session bean metadata files from installed database schema. The input file may comprise one or more lines with the following syntax:

[*]<database table name>=<base entity/factory package
name>.

For example,
*ACM=com.trs.cv.infr.istr.asm.acm
   may generate the following entity/factory metadata files:

com.trs.cv.infr.istr.asm.acm.domain.AcmBean
com.trs.cv.infr.istr.asm.acm.factory.ejbFactoryBeam.

Presence of optional “*” indicates a factory session bean component should be generated in addition to the entity bean component; otherwise, only the entity bean component is generated.

Embodiments of the AutoGen system may also include entity-schema validation that validates entity bean attributes and relationships against database schema table attributes and foreign keys. The entity-schema validation ensures complete object-relational mapping synchronization between IMS entity beans and the IMS relational database schema. For example, entity-schema validation may be executed periodically in order to quickly catch object-relational mapping inconsistencies and reduce application deployment errors.

### Logging

AutoGen may utilize logging to aid with debugging. A logged message may be assigned one of the following log levels: DEBUG, INFO, WARN, and ERROR.

### Performance

The EJB container may issue an entity join query for a particular entity bean finder. The join query retrieves data for entity beans associated with the entity home finder, as well as one or more related entity beans. Use of join queries may require careful analysis, since “joining” too many database tables can harm performance.

A relationship cache may implement an entity join query. Example relationship cache class-level tags:

```
@autogen.relationship-caching-element
    caching-name=“<unique string value that identifies the overall
relationship cache>″
    cmr-field=“<name of entity CMR relationship to eager-load>“
    group-name=“<reference to entity field group>”  // default field
group loads all attributes
    id=“<unique string value that identifies this caching element>”
    parent-id=“<reference to id of parent caching element>”
@autogen.finder
    signature=“<finder signature that mirrors value in ejb.finder or
weblogic.finder>”
    relationship-cache-ref=“<caching-name value>”
@autogen.find-by-primary-key
    relationship-cache-ref=“<caching-name value>”
@autogen.find-all
    relationship-cache-ref=“<caching-name value>”
```

Relationship Cache Method-Level Tags:

// Support for Relationship Caching in ejbSelect methods
@autogen.select
relationship-cache-ref=“<caching-name value>″

### Example

/**
* @ejb.select
* query=“Select Object(a) From A as a Where a.typeCMF = ?1“
* result-type-mapping=“Local”
* @autogen.select
* relationship-cache-ref=“A-RCache“
*/
abstract public java.util.Collection ejbSelectAllByType(java.lang.Long)
throws FinderException;

A relationship cache comprises one or more relationship caching elements. Each relationship caching element specifies caching for a particular entity relationship. A relationship caching element can contain other nested relationship caching elements. A relationship caching element nesting level may correlate with an entity relationship depth relative to the top-level entity.

A Relationship Cache Example:

/** Invocation of findAll( ) results in join query that loads A, B and C
* @autogen.relationship-caching-element
* caching-name=“A-RCache″
* cmr-field=“bCMR”
* id=“AToB”
*
* @autogen.relationship-caching-element
* caching-name=“A-RCache”
* cmr-field=“cCMR”
* id=“BToC”
* parent-id=“AToB”
*
* @ejb.finder
* signature=“java.util.Collection findAllByType(java.lang.Long)”
* query=“Select Object(a) from A as a Where a.typeCMF = ?1”
* @autogen.finder
* signature=“java.util.Collection findAllByType(java.lang.Long)”
* relationship-cache-ref=“A-RCache”
*/

A relationship cache may be defined for the following relationships: one-to-one, one-to-many, and many-to-one. A relationship cache may be highly effective for one-to-one relationships. A relationship cache may also be defined for a relationship between a domain object entity and a composite attribute entity.

A composite attribute for a domain object entity bean may be implemented as a separate entity bean mapped to a separate database table. A composite attribute cache may improve the efficiency of retrieval for a domain object entity with a relationship to a composite attribute entity. A composite attribute cache may be more effective than an entity join query for improving retrieval performance.

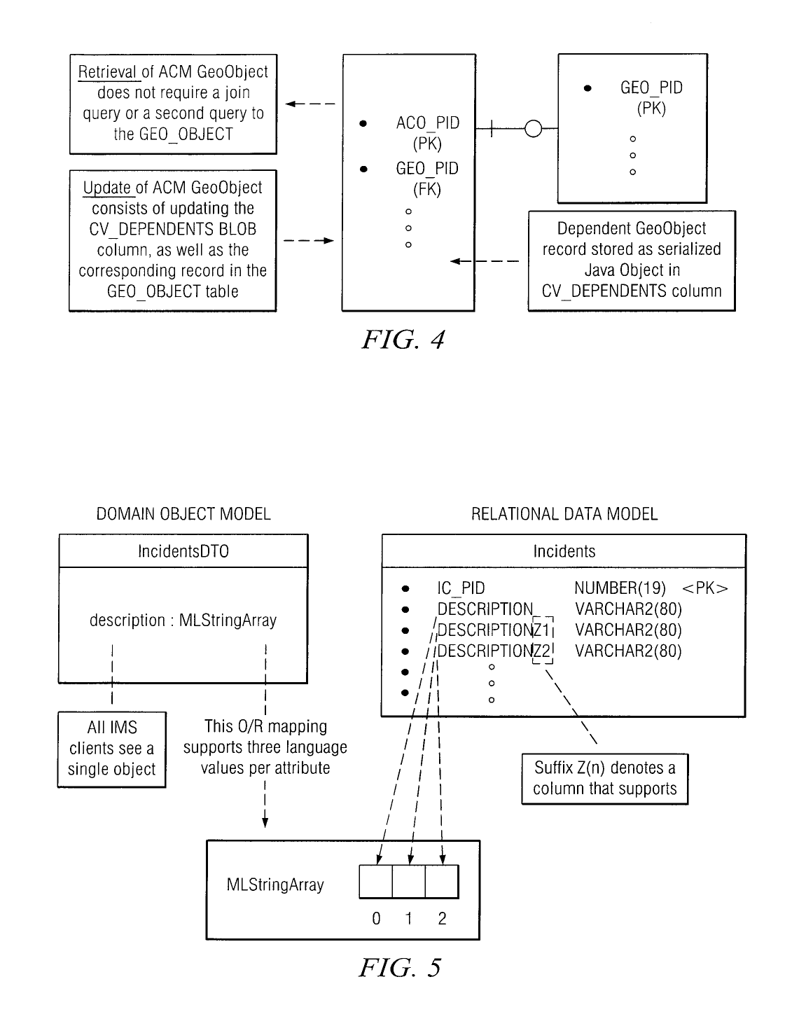

A composite attribute cache is a Binary Large Object (BLOB) column defined in an entity bean's associated database table for the sole purpose of storing the values of related composite attribute entity beans and is described in more detail with reference to FIG. 4.

FIG. 4 presents an example composite attribute cache configuration featuring two related tables, labeled in FIG. 4 as an “ACM Table” and a “GEO_OBJECT” Table. In this example, the composite attribute cache may be configured if there is a performance benefit to configuring a composite attribute cache for a given entity bean. A BLOB column named “CV_DEPENDENTS” may be added to the database table corresponding to the entity bean that caches some or all of its related composite attribute entity beans. In the entity bean that manages the cache, related composite attribute entity beans may be designated that cache in the “CV_DEPENDENTS” column. AutoGen active code generation may then generate composite attribute cache management logic.

A Composite Attribute Cache Example:

```
/**
* @ejb.bean
*  :
* @autogen.bean
*  :
* @autogen.composite-attribute-cache
*  column-name=“<name of BLOB column>”
*  class-name=“<name of generated dependent value class>”
*/
abstract public class ABean extends DomainObjectBean ... {
    /**
    * @autogen.relation
    *  type=“composition”
    *  composite-attribute-cache=“true”
    * @ejb.relation
    *  :
    */
  public abstract BLocal getBCMR( ) throws EJBException;
```

Composite attribute cache design may allow standard SQL query capability against composite attribute values. In addition, composite attribute cache design may eliminate issues associated with maintaining Java serialization compatibility against successive versions of a composite attribute class.

Updates to cached composite attributes may be performed through the IMS in order to ensure proper synchronization between the composite attribute cache and the corresponding composite attribute entities. If a cache exists for a composite attribute, and data for that composite attribute is loaded outside of the IMS, the mechanism that loads the data may also flush the corresponding cache by assigning “null” to the designated BLOB column.

Embodiments may also include composite attribute entity update logic. Default composite update logic generated in the owning domain object entity bean may differ depending upon the relationship cardinality between the domain object entity and the composite attribute entity. For a one-to-one relationship, a composite attribute entity bean is always created if it doesn't already exist and is always over-written if it already exists. For a one-to-many relationship, a composite attribute entity bean is created if it doesn't already exist and deleted if it already exists, replaced with a new composite attribute entity bean.

Overwriting composite attribute entities in a one-to-many relationship can be problematic if a unique key constraint exists for a composite attribute entity attribute and deferred constraint checking by the database server is not an option. AutoGen may provide developers with the ability to overwrite an existing composite attribute entity bean in a one-to-many relationship if there are no uniqueness constraints defined for any attributes owned by the composite attribute entity.

Example composite attribute update strategy definition:

```
@autogen.bean
    beantype=“entity”
    objecttype=“composite”
    overwrite-on-update=“true” | ”false”  // option only applicable for
one-to-many relationship
```

### Multilingual

FIG. 5 presents an example of a multilingual object-relational mapping. AutoGen may provide an object/relational persistent data mapping that supports management of multiple data values for a particular domain object attribute. In a multilingual object-relational mapping design, the number of language values supported per attribute is an AutoGen configurable parameter. In a relational model, a column is defined to store a primary language value. Additional columns are defined in the same relational database table to support alternate language values. In an object model, a domain object string attribute designated as multilingual is of type “MLStringArray”. An MLStringArray object contains all (primary+alternate(s)) language values. In object-relational mapping, for each multilingual domain object attribute, AutoGen generates code to map each language-specific relational table column to a designated index position in the attribute's MLStringArray.

An Entity Bean Multilingual Configuration Example:

```
/**
  @autogen.bean
    beantype=“entity”
    pattern=“fdas”
    :
*/
public abstract class IncidentsBean extends DomainObjectBean
implements
EntityBean {
      /**
      @ejb.persistence
      column-name=“DESCRIPTION”
    @autogen.persistence
          multilingual=“true”  // optional method tag attribute
that is false if omitted
  */
  public abstract java.lang.String getDescriptionCMF( );
    :
}
```

### Configuration Examples

General Configuration XML Elements Example:

```
<autogen-config>
    <multilingual>
      <number-of-languages>
        number  of  language  values  supported  per  multilingual
attribute
      </number-of-languages>
      <db-column-unique-symbol>
        column suffix that identifies alternate language table columns
      </db-column-unique-symbol>
    </multilingual>
</autogen-config>
```

Example Autogen-config.xml:

```
<autogen-config>
    <multilingual>
      <number-of-languages>
    3
  </number-of-languages>
  <db-column-unique-symbol>
    z
  </db-column-unique-symbol>
    </multilingual>
</autogen-config>
```

Some AutoGen meta-data tag configuration options may be specified for a large set of AutoGen-controlled EJB components, as opposed to for each individual EJB component. Examples include allocating entity beans to global entity caches, enabling generation of cluster-aware session bean stub proxies, and defining the concurrency strategy for domain object and composite attribute entity beans.

AutoGen also supports the ability to dynamically insert AutoGen/XDoclet meta-data tags into a specified set of EJB components at build time.

Example tag configuration XML elements:

```
<Tag-Rules>
    <Tag-Rule>
        <Package-Name>Target Java Class Package</Package-Name>
        <Object-Type>Target AutoGen Object Type</Object-Type>
        <Tag>
        <name>AutoGen/XDoclet meta-data tag name</name>
        <attribute>AutoGen/XDoclet  meta-data  tag  attribute
name</attribute>
        <value>AutoGen/XDoclet meta-data tag attribute value</value>
    </Tag>
    <Tag>
      :
    </Tag>
    </Tag-Rule>
      :
    <Tag-Rule>
      :
    </Tag-Rule>
</Tag-Rules>
```

Example Tag-configurator.xml:

```
<Tag-Rules>
    <Tag-Rule>
      <Package-Name>com.trs.cv.infr</Package-Name>
      <Object-Type>domainobject</Object-Type>
      <Tag>
        <name>weblogic.cache-ref</name>
        <attribute>cache-name</attribute>
        <value>DomainObjectEntityCache</value>
      </Tag>
  <Tag>
        <name>weblogic.cache-ref</name>
        <attribute>concurrency-strategy</attribute>
        <value>Optimistic</value>
      </Tag-Rule>
</Tag-Rules>
```

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic. As used in this document, “each” refers to each member of a set or each member of a subset of a set.

Modifications, additions, or omissions may be made to the methods described herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method for generating code, comprising:
receiving a database file describing a database and a database schema, the database comprising a plurality of database records;
receiving a metadata tag, the metadata tag describing a business relationship between two or more database records;
integrating the database file and the metadata tag to form a merged file; and
using a computer system, converting the merged file into code.

2. The method of claim 1, the converting the merged file into code comprising:
parsing a structure of the merged file;
identifying a design pattern of the merged file, the design pattern describing a template; and
inserting the code into the merged file according to the template.

3. The method of claim 1, the receiving a database file describing a database and a database schema comprising:
receiving the database and the database schema, the database and the database schema being encoded in a unique format; and
generating the database file to describe the database and the database schema in a generic format.

4. The method of claim 1:
the database comprising a relational database, the method further comprising:
the method further comprising mapping the relational database and the database schema to an object representation of the database to create an object-relational mapping.

5. The method of claim 4, further comprising:
incorporating the object-relational mapping into the code; and
validating the object-relational mapping against the database and the database schema.

6. The method of claim 1, the code providing an interface for an external application, the interface providing a method for modifying the data records in the database.

7. The method of claim 1, further comprising:
using the merged file, generating an object representation of the data records; and
providing an interface that maps the object representation to the database and the database schema.

8. A computer-readable medium having computer-executable instructions, when executed by a computer configured to:
receive a database file describing a database and a database schema, the database comprising a plurality of database records;
receive a metadata tag, the metadata tag describing a business relationship between two or more database records;
integrate the database file and the metadata tag to form a merged file; and
convert the merged file into code.

9. The computer-readable medium of claim 8, the instructions when executed further configured to convert the merged file into code by:
parsing a structure of the merged file;
identifying a design pattern of the merged file, the design pattern describing a template; and
inserting code into the merged file according to the template.

10. The computer-readable medium of claim 8, the instructions when executed further configured to receive a database file describing a database and a database schema by:
receiving the database and the database schema, the database and the database schema being encoded in a unique format; and
generating the database file to describe the database and the database schema in a generic format.

11. The computer-readable medium of claim 8:
the database comprising a relational database; and
wherein the database is a relational database, the instructions when executed further configured to map the relational database and the database schema to an object representation of the database to create an object-relational mapping.

12. The computer-readable medium of claim 11, the instructions when executed further configured to convert the merged file into code by:
incorporating the object-relational mapping into the code; and
validating the object-relational mapping against the database and the database schema.

13. The computer-readable medium of claim 8, the code providing an interface for an external application, the interface providing a method for modifying the data records in the database.

14. The computer-readable medium of claim 8, the instructions when executed further configured convert the merged file into code by:
using the merged file, generating an object representation of the data records; and
providing an interface that maps the object representation to the database and the database schema.

15. A method for generating code, comprising:
receiving a database file describing a relational database and a relational database schema, the database comprising a plurality of database records;
mapping the relational database and the database schema to an object representation of the database to create an object-relational mapping.
receiving a metadata tag, the metadata tag describing a business relationship between two or more database records;
integrating the object-relational mapping and the metadata tag to form a merged file; and
using a computer system, converting the merged file into code.

16. The method of claim 15, the converting the merged file into code comprising:
parsing a structure of the merged file;
identifying a design pattern of the merged file, the design pattern describing a template; and
inserting the code into the merged file according to the template.

17. The method of claim 15, the receiving a database file describing a database relational and a relational database schema comprising:
receiving the relational database and the relational database schema, the database and the database schema being encoded in a unique format; and
generating the database file to describe the database and the database schema in a generic format.

18. The method of claim 15, further comprising:
incorporating the object-relational mapping into the code; and
validating the object-relational mapping against the relational database and the relational database schema.

19. The method of claim 15, the code providing an interface for an external application, the interface providing a method for modifying the data records in the relational database.

20. The method of claim 15, the code providing an interface for an external application, the interface providing access to the relational database based on the object-relational mapping.
